(19) United States
(12) Patent Application Publication
(10) Pub. No.: US 2006/0253323 A1
(43) Pub. Date: Nov. 9, 2006

(54) System and method for online trading of television advertising space

(75) Inventors: John Phan, Houston, TX (US); Allen D. Easty, Plano, TX (US)

Correspondence Address: HAYNES AND BOONE, LLP, 901 MAIN STREET, SUITE 3100, DALLAS, TX, 75202, US

(73) Assignee: Optical Entertainment Network, Inc., Houston, TX (US)

(21) Appl. No.: 11/374,882

(22) Filed: Mar. 14, 2006

Related U.S. Application Data
(60) Provisional application No. 60/661,709, filed on Mar. 15, 2005.
(60) Provisional application No. 60/663,943, filed on Mar. 21, 2005.

(51) Int. Cl. G06Q 30/00; H04N 7/10

(52) U.S. Cl. 705/14; 725/32

(57) ABSTRACT

An online targeted advertising system comprises a first interface operable to enable a TV program distributor to access an online targeted advertising exchange and identify ad avails as commodities, a second interface operable to enable a TV-viewing household to access the online targeted advertising exchange and carry out transactions related to the identified ad avails, and a third interface operable to enable an advertiser to access the online targeted advertising exchange and carry out transactions related to the identified ad avails.

### RELATED PATENT APPLICATIONS

This patent application claims the benefit of U.S. Provisional Patent Application Nos. 60/661,709 and 60/663,943, filed on Mar. 15, 2005 and Mar. 21, 2005, respectively, both entitled System and Method for Household-Targeted Advertising and Online Trading of Television Advertising Space, which is incorporated herein by reference.

This patent application is related to co-pending U.S. Non-Provisional Patent Application entitled System and Method for Household-Targeted Advertising (Attorney Docket No. 36054.10) filed on Mar. 14, 2006, which is incorporated herein by reference.

### BACKGROUND

The advent of Internet Protocol Television (IPTV) will forever change how digital entertainment and communications is delivered into households. Voice, video and data applications will all be seamlessly converged to deliver the first truly integrated home entertainment and communications experience.

Arguably, one of the most exciting new business models emerging from IPTV technology is IP targeted advertising. What this means is that the 30-second television ad avail can now be targeted to the intended viewing audience based on economic, demographic, geographic, lifestyle, and/or personal preferences and interests, at the household level. Ultimately, no two households will see the same set of commercials. For example, a golf fanatic would receive commercials related to golf merchandise or services. An avid gardener would receive advertisements focused on gardening supplies and services.

### BRIEF DESCRIPTION OF THE DRAWINGS

Aspects of the present disclosure are best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a simplified block diagram showing the entities involved in an embodiment of an online targeted advertising system;

FIG. 2 is a more detailed block diagram of the entities involved in an online targeted advertising system;

FIG. 3 is a simplified block diagram of an embodiment of a coordinated advertising strategy across multiple platforms;

FIG. 4 is a more detailed block diagram of an embodiment of an online targeted advertising system using brokers;

FIG. 5 is a more detailed block diagram of an embodiment of the online targeted advertising system;

FIG. 6 is a more detailed block diagram of an embodiment of profile data used to target viewing households of the online targeted advertising system; and

FIG. 7 is a simplified flowchart of an embodiment of a process for an advertiser to access the online targeted advertising system.

### DETAILED DESCRIPTION

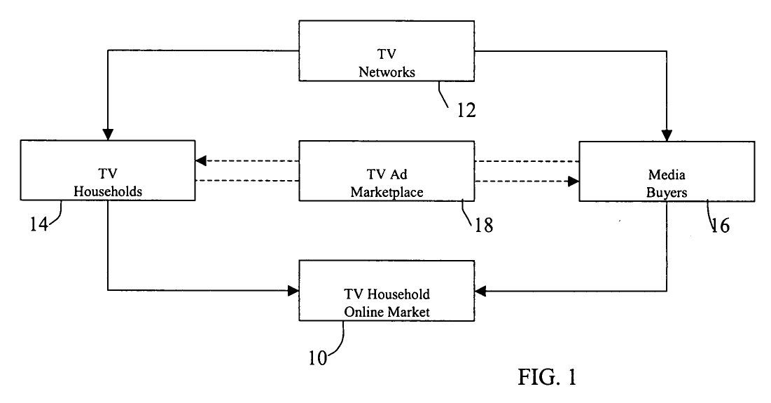

Referring to FIG. 1, an online marketplace 10 will be realized by creating a safe and simple platform where the television networks, TV households and media buyers (or advertisers) can congregate on a single venue to buy and sell TV ad space. Each of these entities may interact with one another via the online marketplace 10. System 10 may comprise a TV network interface module 12, a TV household interface module 14, and a media buyer interface module 16. The ad avails are the commodities to be identified, offered, bought, optioned, traded, etc. in the online marketplace 10.

In the conventional business model, shown in phantom lines, the broadcast television networks produce programs to attract a viewership base, with the objective of selling the ad spots during the program to generate revenue. The ad spaces are sold to intermediary media buyers and advertisers in an ad marketplace 18, who then insert their ad content for delivery to the TV audience. Therefore, the more viewers a program attracts, the larger will be the demand for that ad space and the higher the price will be paid by advertisers to own it.

Currently, advertisers can only purchase TV ad time across a mass market and not for a particular micro-market such as a neighborhood or an individual TV household. Further, televisions ad avails are pre-sold under a private negotiated market called the Upfront Market. The Upfront market takes place annually in late May or early June. During this event, executives from the broadcast networks meet with media buyers and advertising agencies to negotiate the sale of ad avails in advance of the programming season. This market functions much like a traditional primary market where buyers and sellers meet to transact the first sale of TV ad inventory. However, information sharing under this format is poor and there is no open communications of the bid and ask for each ad avail transacted. What's worse is the lack of an organized secondary market. The so called Scatter Market is where buyers and sellers try to sell off or buy ad inventories previously negotiated in the Upfront Market. In this arrangement, there is no independent third party overseeing the process and ensure that buyers and sellers are matched. Instead, the Scatter market is a disorderly process that fails to match all interested buyers with all interested sellers of ad inventory.

However, an IP ad insertion technology described in co-pending U.S. patent application entitled System and Method for Household-Targeted Advertising changes all of this. The IP ad insertion technology allows for an ad impression to be targeted to as precise as one household unit or to as large as a nationwide campaign.

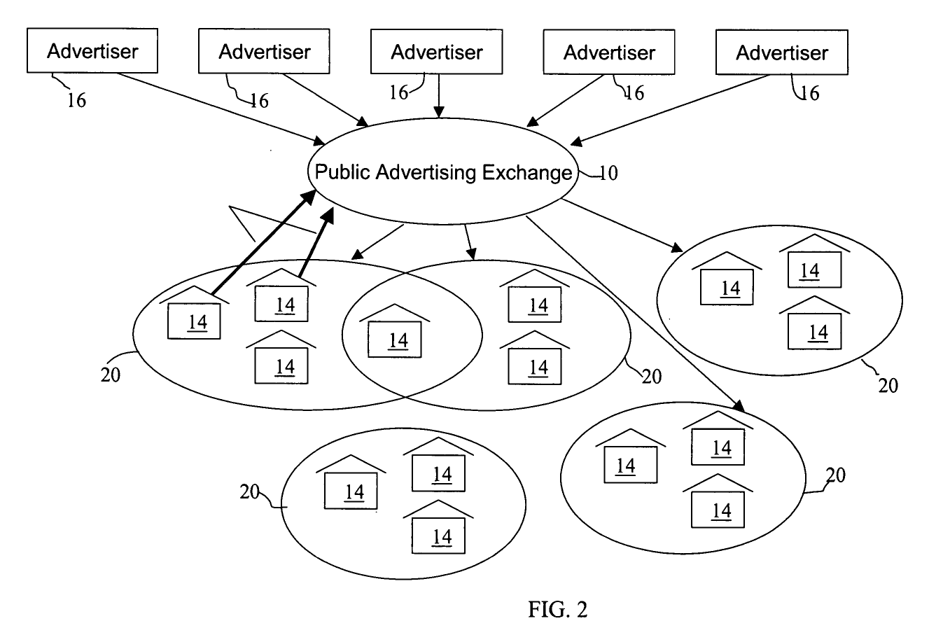

The implications of bringing the TV household into the market for TV ad space are tremendous. The end consumer can now control what ad content they watch, if any at all. Media buyers will now bid against TV households to control television ad space. An online auction market (or public advertising exchange) 10, as shown in FIG. 2, will be the platform on which buyers and sellers interact to control the inventory of TV ad avails, including the households 14 themselves. The dynamics of supply and demand will determine the equilibrium price (or fair market value) for each ad avail being auctioned. This is in contrast with the current practice where the prices paid for ad spots are determined by a private negotiated sales process between the broadcast networks and the media buyers.

In the new advertising model, all parties win: the TV networks 12, the advertisers 16 and the TV households 14. TV networks are able to extract higher prices for their ad spots and have a broader market from which to sell their ad spots. Advertisers are able to design more targeted advertising campaigns rich with interactive features that were never before possible. The ads can target individual households or a small number of households that make up household groups 20. TV households are able to control the commercials they see and have access to advertising spots.

Cable and Satellite-based broadcasts have a technical limitation in how advertising is “inserted” into the television distribution system. Cable and satellite systems have to “insert” the advertisement over the network channel's programming. A dedicated device stores the ad and when signaled, it stops feed coming in from the satellite downlink and starts to play the ad. When the ad is complete, it restores the original signal from the network's satellite feed. Since this approach requires dedicated equipment for each channel of programming, it can be expensive to cover all channels in a programmer's line-up. This leaves a large amount of unused inventory. It also makes it difficult to target demographics smaller than the overall size of the network. Further, advertisers must predict what channel their target audience will be watching. If they are right and the audience is there, they score a success. If they are wrong and the target audience is watching another channel—they lose. There are no guarantees.

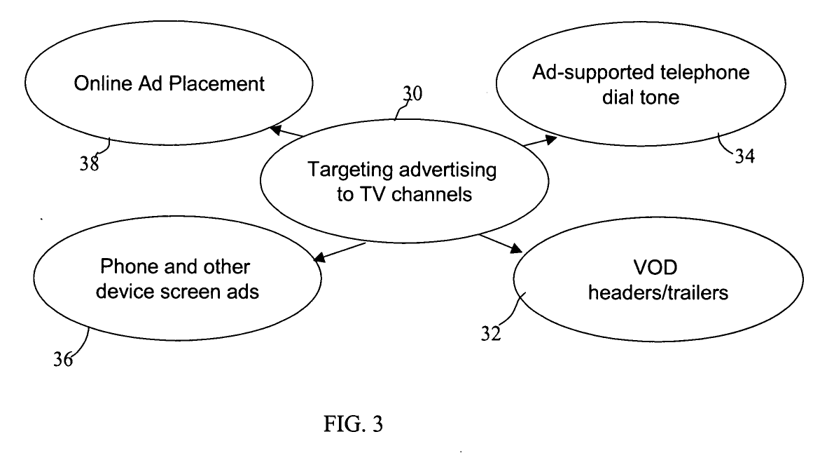

The target advertising model 30 described herein creates many secondary benefits. Referring to FIG. 3, a second source of advertising inventory is created for content such as Pay-Per-View events, Movies-On-Demand (Video-On-Demand or VOD), and Subscription VOD. This can be premium advertising spots where merchandise associated with the program can be advertised. For example, showing movie or television trailers before or after a VOD program (32) or ads for consumer merchandise associated with the program.

Further, because the household-targeted system is based on IP technology (or another enabling technology), the computer has a much more powerful role in how the network operates and what it is capable of. All household-targeted advertising services are IP based, including PC Internet services and telecommunications. Since these services are also IP based and use computers to manage their capabilities, they can also share in the advertising model. Examples include: offering free voice phone dial-tone or long-distance if the customer first listens to a 5 to 30 second digital audio advertisement (34); showing an instant Pizza Hut coupon on the phone's display (36); and setting the banner ads on the home page when the personal computer logs into the Internet (38).

It may be seen that a coordinated advertising strategy is possible. The advertiser now has the ability to coordinate advertising media across all services to provide a more consistent message to consumers. For example, between 5:00 PM and 7:00 PM, the viewer will see a Pizza Hut ad on TV, a Pizza Hut banner ad on their Internet service, and an instant coupon on their phone for a Pizza Hut large pizza.

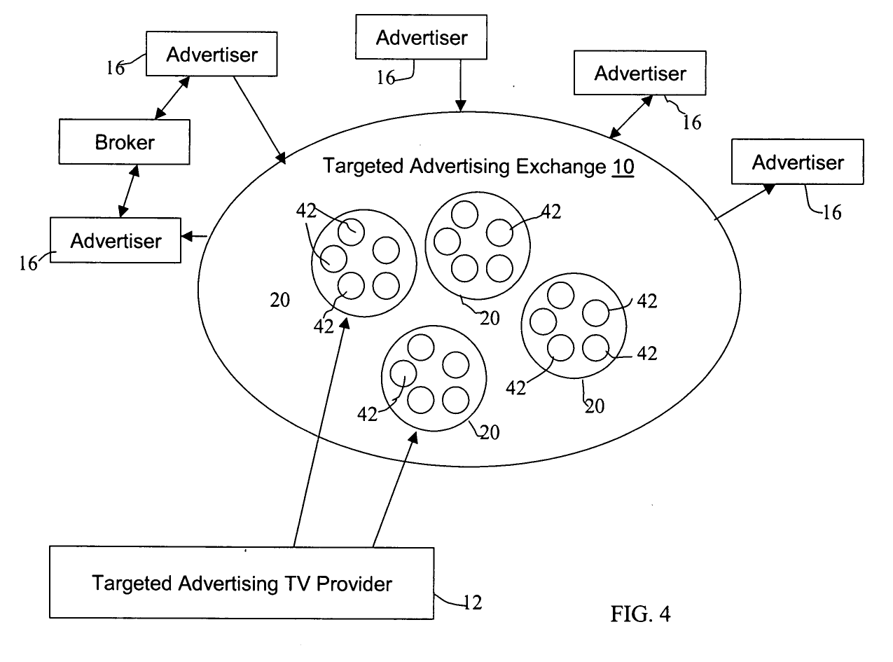

Referring to FIG. 4, numerous new business models will be created as a result of the online marketplace 10, particularly the creation of a brokerage business based on targeted advertising. Brokers 40 are market-makers—they bring buyers and sellers together and facilitate transactions. Brokers 40 play a frequent role in business-to-business (B2B), business-to-consumer (B2C), or consumer-to-consumer (C2C) markets. A broker 40 may charge a fee or commission for each transaction it enables. The formula for fees can vary. Brokerage models include:

Marketplace Exchange—offers a full range of services covering the transaction process, from market assessment to negotiation and fulfillment. Exchanges operate independently or are backed by an industry consortium. [e.g. Orbitz, ChemConnect];

Buy/Sell Fulfillment—takes customer orders to buy or sell a product or service, including terms like price and delivery. [e.g. CarsDirect, Respond.com];

Demand Collection System—the patented “name-your-price” model pioneered by Priceline.com. Prospective buyer makes a final (binding) bid for a specified good or service, and the broker arranges fulfillment. [e.g. Priceline.com];

Auction Broker—conducts auctions for sellers (individuals or merchants). Broker charges the seller a listing fee and commission scaled with the value of the transaction. Auctions vary widely in terms of the offering and bidding rules. [e.g. eBay];

Transaction Broker—provides a third-party payment mechanism for buyers and sellers to settle a transaction. [e.g. PayPal, Escrow.com];

Distributor—is a catalog operation that connects a large number of product manufacturers with volume and retail buyers. Broker facilitates business transactions between franchised distributors and their trading partners;

Search Agent—a software agent or “robot” used to search-out the price and availability for a good or service specified by the buyer, or to locate hard to find information. [e.g. MySimon, DealTime]; and

Virtual Marketplace—or virtual mall, a hosting service for online merchants that charges setup, monthly listing, and/or transaction fees. May also provide automated transaction and relationship marketing services. [e.g. zShops and Merchant Services at Amazon.com];

Television ad space (or ad avails) 42 is a commodity. Just like wheat and grain commodities that trade daily on the Chicago Board Options Exchange, Media Credit Derivatives (MCD) will represent a futures contract that entitle the holder to ownership of a particular ad spot. The MCD contract will specify the time of day the ad avail will play, the market that the ad spot will target and the other demographic and economic considerations. However, rather than trade on a regulated options exchange, MCD will be freely traded over the online market 10 for ad avails 42. All targeted ad buyers and sellers will submit their bid and ask, via the online market exchange, for ad avails. Quotes of all available ad inventory will be displayed in real time thereby enabling transactions to occur around the clock. There will now always be a transparent liquid market for ad inventories. No longer will buyers of ad space have to hold on to unwanted ad inventories should their TV ad campaign preferences change during the programming season. Now participants can log on to the online market 10 for ad avails 42 and locate buyers for their inventories.

Television ad inventory comes from two sources. The first is known within the cable and satellite industries as “ad avails”. The second is from within the programming schedule. While all television distribution systems have the ability to utilize this inventory, the limitations of cable and satellite television technologies and the associated economics hamper the ability to utilize the inventory in a way that scales economically and technically. At best, only a small percentage of this inventory is used today.

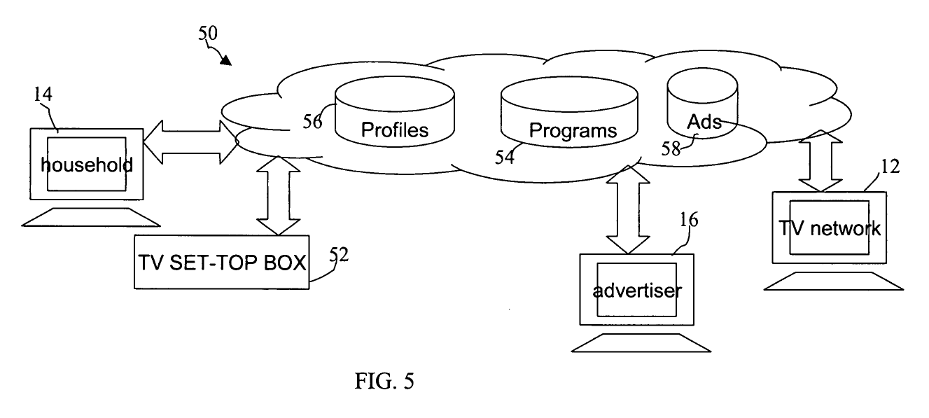

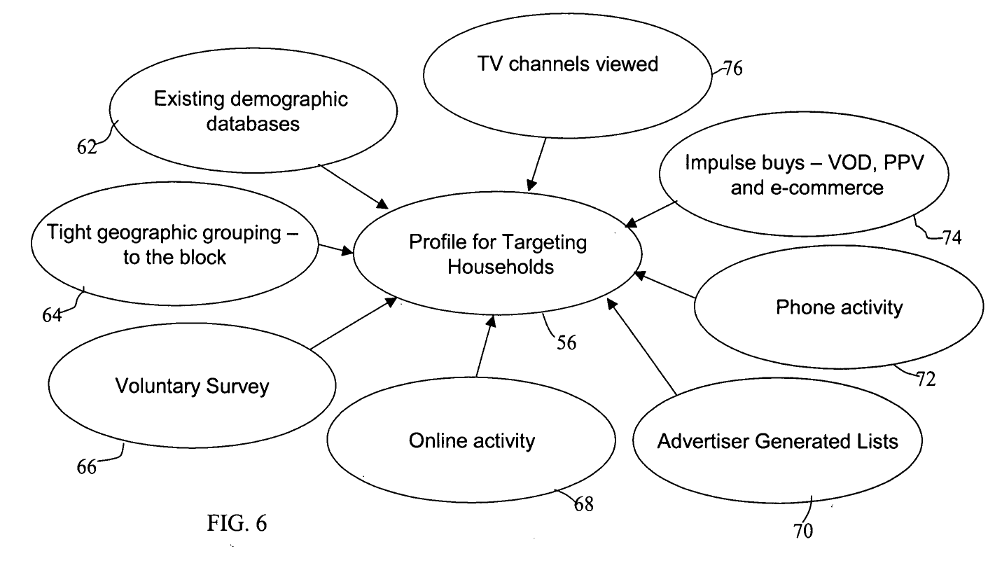

Referring to FIG. 5, a digital IP ad insertion system 50 changes the state-of-the-art for advertising. Unlike cable and satellite that insert advertisements at the point where distribution begins, the new advertising model performs the ad insertion in TV Set-Top Boxes (STB) 52 located on the customer's premises or in the viewer's household. This changes the model—instead of playing an advertisement and hoping someone is there to see it, the advertisement is played directly to the set-top box and plays no matter what channel the viewer is watching. Ad avails are negotiated for every channel in the programming line-up. The programming and ad time slots are stored in a program database 54. Another database 56 is used to store of customer profiles and maintains an advertisement list for each household that is unique for that household. The advertisement themselves are stored in yet another database 58. The household profile may include information such as (shown in FIG. 6): demographics 62, geographic grouping 64, personal preferences and interests based on voluntary surveys 66, online activities 68, advertiser generated data 70, telephone activities 72, past purchases (such as VOD, PPV, etc.) 74, and TV viewing habits 76. This allows for advertising to be highly targeted, for example:

A household that has watched 10 hours of the golf channel on the living room TV this month may be targeted for the ad for the Big Bertha golf club;

A household that has watched an average of 15 hours of the SciFi channel each month amongst all TVs in the household may be targeted for the ad for the DVD set of Star Wars movies;

A household living in the 75075 zip code may be targeted for the ad for the local Taco Bell restaurant and could have a banner across the bottom generated by the STB with the local address and phone number; and

The locally owned and operated pizza place could advertise to its list of the top 200 addresses in its delivery area every Friday and Saturday night between the hours of 5:00 PM and 7:30 PM regardless of what channel the household was watching.

The last example describes a powerful feature of this ad model, something that cable and satellite cannot do. Guarantee that no matter what channel the viewer is watching that within a certain time period, an advertisement will be shown. This can be done because almost all channels provided have ad avails and the likelihood of hitting a 30-second spot within a one to two hour span of viewing is high.

A set-top box receives information in the video streams about the channels and times where ad avails exist. When an ad avail is signaled (usually a few seconds before the actual avail), an ad specifically chosen for this household and time is pulled from network storage to the set-top box and spliced into the video stream for forwarding to the TV set. When the ad is completed, the viewer is returned to the original video stream.

What's more important, is that the ads hit the targeted demographic. This can be audited and assured based on the ability of the STB to declare a successful play of the ad. In addition, the ad played while the viewer watched a particular program could be different than the ad the neighbor received even if they were all watching the same program on the same channel and at the same time.

Ad avails are not the only time that advertisements can be played. Ads can be slots programmed before and after Pay-Per-View events, sporting events such as “MLB Extra Innings (Major League Baseball),” “NHL Center-Ice,” or “NBA League Pass.” Pay-Per-View programming and On-Demand movies and television can also provide great advertising opportunities.

In the new advertising model, both the corner coffee shop and the national chain can have equal access to the marketplace. Instead of charging a flat fee for a time slot where an advertiser has to hope that viewers will be there watching, the new advertising model uses an “Ad Impression” billing model. Advertisers pay a per-impression fee for each time the ad is played over a STB. Billing models can either be a pay-as-you-go invoicing system or a pre-paid model where a specific number of impressions are guaranteed for a single flat rate. Either method, the advertiser is guaranteed a complete impression. If a viewer only watches part of the ad, it is returned to the inventory for replay.

Since the ad insertion model is powered by a computer database system, the advertiser can select from a variety of impression demographics. For example, advertisers can tailor an impression for a specific behavior, a location, time of day, television viewing habit, Internet browsing habit, where they place phone calls to. A few illustrations would be:

Selecting the delivery area for a local pizza place;

Selecting a household because it watches 3 hours of the cartoon channel everyday;

Selecting all users who have visited a major automobile web site in the past month;

Selecting all households that watch as least one NFL game a month or selecting a household that never watches an NFL game;

Selecting all households in a zip code recently hit by a hail storm; and

Selecting households that regularly call an area code in another state (what would Southwest Airlines do with this capability).

Since the computer can add text and graphics to any ad based on instructions in the ad insertion database, it is possible for an advertiser to target a specific product at a specific household. For example, a Texas household who calls an Iowa area code every month may be targeted for a Southwest Airlines ad that offers a discounted ticket between Dallas and Des Moines if purchased within a specific time. The WAM information button could preserve that information without interrupting the programming and later the viewer could retrieve it on their TV or Personal Computer to take advantage of the offer and order the tickets.

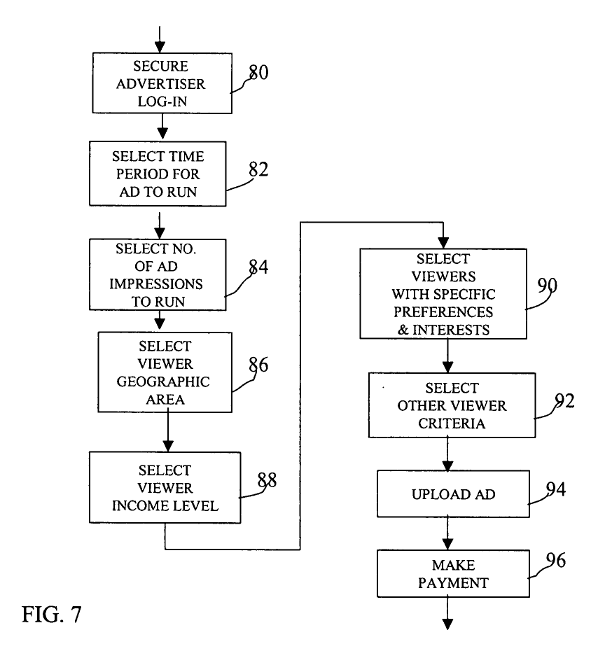

Referring to FIG. 7, advertisers have the option to use a web-based interface over the Internet to purchase, place, and control their advertising. In step 80, an advertiser may enter the online targeted ad market by providing his log-in data such as user name and password. There may be a menu of options for the advertiser to manage his advertising account. The following process provides an exemplary sequence of steps that may be executed in different order, and one or more steps may be optional steps that are not required. In step 82, the advertiser may select the time period for an ad to run. In step 84, he may enter the number of ad impressions he would like to run over the previously-entered time period. In step 86, a viewer geographic region may be specified or selected. For example, a locally-owned corner dry cleaner may call up and view a map to specify and show the area where the advertisement is to be shown. In step 88, the advertiser may additionally select or enter an income level for the intended target household. In step 90, the advertiser may enter or select specific viewer preferences and interests that may indicate a good reception of his advertising pitch. In step 92, the advertiser may select or specify additional criteria to further target the viewership of his advertisement. In steps 94 and 96, the advertiser may then upload the ad, and enter credit card account or other payment information to complete the process. This process works the same way for a larger advertiser and a small advertiser. The advertiser can also change the ad at a moments notice. As long as the ad is not streaming at the moment, it can be replaced. The advertiser could instantly change ads based on current events, changes in the business or marketing strategy, or viewer reaction.

There are endless possibilities provided by this new advertising model. If it is raining, advertise rain gear available at the local quick-shop. If is unusually hot, advertise ice cream and refreshing drinks available at the corner convenience store. If a local crime occurs, advertise home security systems for installation by local contractors. If it hails, advertise dent repair services by an auto body shop. The potential is limited only by the imagination of the advertisers.

What makes all of this technical possible is the combination of excellent software design, a network based on open Internet Protocol (IP) standards, and Fiber-To-The-Home technology based on Ethernet and IP. Today, cable and satellite can only take advantage of the dedicated hardware used and its features are limited by what that hardware is capable of. In the new advertising system, computers and networks work in harmony, just as they do on the Internet, to seamlessly coordinate the workings of the television STB, the phone, and the Internet services.

Glossary of Terms

Ad Avails—Advertising spots available to a cable operator to insert advertising on a cable network. Radio and television ads are typically sold as 30 and 60 second spots.

Advertising Media—Newspaper, radio, broadcast TV, cable TV, outdoor, and direct mail.

Broadcast Networks—Also known as the owners of programming content. Owns approximately 75% of the television advertising space, with the balance allotted to the cable networks.

Broadcast Upfront—The upfront market in which broadcast network ad time are purchased and sold.

Cable Upfront—The upfront market in which cable network ad time are purchased and sold.

CPM (Cost Per Thousand)—Cost per thousand is your standard measure of media cost efficiency. It relates the cost of a medium to its audience delivery. To calculate CPM, divide media cost by target impressions, in thousands.

Day Parts—Segments of the television broadcast day. These are:

DMA (Designated Market Area)—Used by A. C. Nielsen, the term refers to a geographical market definition whereby each county is assigned exclusively to one television market. The DMA rating is based on counties where originating stations enjoy a high proportion of viewing compared to outside station viewing.

Early Morning: 5:00 am-9:00 am; Daytime: 9:00 am-4:00 pm; Early Fringe: 4:00 pm-8:00 pm; Primetime: 8:00 pm-10:00 pm; Late Evening: 10:00 pm-1:00 am; Late Night: 1:00 am-5:00 am

FTTH (Fiber-to-the-Home)—Fiber-to-the-Home represents a fiber optic network that connects directly to the home and not to the curb or the node. The result is an end-to-end fiber connection with limited degradation in bandwidth.

Internet Protocol—The set of protocols used to communicate over the Internet.

Impressions—Impressions are another way to express audience size. Each exposure to your advertising is an impression.

IPTV (Internet Protocol Television)—Television delivered using Internet Protocol technology. The result is full digital quality picture with no limitations on sprectrum.

Local (Cable) Networks—Also known as the distributors of programming content.

Rate Card—Established rates for space and time purchased. Also gives ad and spot production specifications as well as deadline information.

Scatter Market—Spot market in which TV ad time is sold during a programming season and not in advance.

Upfront Market—Forward market where advertisers and media buyers and the cable and broadcast networks gather to negotiate the private sale of TV ad time ahead of the programming season. The upfront market takes place annually between late May and early June of every year.

According to the system and method described above, by using a set-top box as part of customer premises equipment, the advertising for each household may be customized and tailored according to a number of criteria such as demographics, income level, personal interests, ads already seen, favorite TV channels, and other settings. A set-top box receives information in the video streams about the channels and times where ad avails exist. When an ad avail is signaled (usually a few seconds before the actual avail), an ad specifically chosen for this household and time is pulled from network storage to the set-top box and spliced into the video stream for forwarding to the TV set. When the ad is completed, the viewer is returned to the original video stream. It does matter which television channel the household is viewing, the targeted ads can be inserted into the avails of any program.

Although embodiments of the present disclosure have been described in detail, those skilled in the art should understand that they may make various changes, substitutions and alterations herein without departing from the spirit and scope of the present disclosure. Accordingly, all such changes, substitutions and alterations are intended to be included within the scope of the present disclosure as defined in the following claims. In the claims, means-plus-function clauses are intended to cover the structures described herein as performing the recited function and not only structural equivalents, but also equivalent structures.

What is claimed is:

1. An online targeted advertising system, comprising:
a first interface operable to enable a TV program distributor to access an online targeted advertising exchange and identify ad avails as commodities;
a second interface operable to enable a TV-viewing household to access the online targeted advertising exchange and carry out transactions related to the identified ad avails; and
a third interface operable to enable an advertiser to access the online targeted advertising exchange and carry out transactions related to the identified ad avails.

2. The system of claim 1, further comprising a database for storing TV-viewing household profile data.

3. The system of claim 2, wherein the TV-viewing household profile database comprises at least one of demographics data, geographic data, survey data, personal preference data, online activity data, advertiser-generated data, telephone activity data, past purchases data, and TV viewing data.

4. The system of claim 1, further comprising a database for storing TV programming data and time slots for running advertisements.

5. The system of claim 1, further comprising a database for storing advertisements.

6. The system of claim 1, wherein the third interface further comprises a coordinated cross-platform advertising option enabling the advertiser to deliver consistent targeted advertising via at least one of online advertisement, ad-supported telephone dial-tone, mobile device display advertisement, and video-on-demand header and trailer advertisement.

7. The system of claim 1, wherein the third interface further comprises a specification of a time period for running an ad.

8. The system of claim 1, wherein the third interface further comprises a specification of a number of ad impressions.

9. The system of claim 1, wherein the third interface further comprises an upload interface for uploading an ad by the advertiser.

10. The system of claim 1, wherein the third interface further comprises a specification of payment.

11. The system of claim 1, further comprising a fourth interface operable to enable a broker access to the online targeted advertising exchange to facilitate ad avail transactions between advertisers.

12. The system of claim 1, further comprising a fourth interface operable to enable a broker access to the online targeted advertising exchange to facilitate ad avail transactions between the TV-viewing household and the advertiser.

13. The system of claim 1, further comprising a fourth interface operable to enable a broker access to the online targeted advertising exchange to facilitate ad avail transactions between the TV program distributor and the advertiser.

14. The system of claim 1, further comprising a fourth interface operable to enable a broker access to the online targeted advertising exchange to facilitate ad avail transactions between the TV-viewing household and the TV program distributor.

15. An online targeted advertising method, comprising:
enabling a TV program distributor access to an online targeted advertising exchange and identify ad avails as commodities;
enabling a TV-viewing household access to the online targeted advertising exchange and carry out transactions related to the identified ad avails; and
enabling an advertiser access to the online targeted advertising exchange and carry out transactions related to the identified ad avails.

16. The method of claim 15, further comprising enabling the advertiser access to stored TV-viewing household profile data.

17. The method of claim 16, wherein enabling the advertiser access comprises enabling the advertiser access to at least one of demographics data, geographic data, survey data, personal preference data, online activity data, advertiser-generated data, telephone activity data, past purchases data, and TV viewing data.

18. The method of claim 15, further comprising enabling the advertiser access to stored TV programming data and time slots for running advertisements.

19. The method of claim 15, further comprising enabling the advertiser to deliver consistent targeted advertising via at least one of online advertisement, ad-supported telephone dial-tone, mobile device display advertisement, and video-on-demand header and trailer advertisement.

20. The method of claim 15, further comprising enabling the advertiser to specify a time period for running an ad.

21. The method of claim 15, further comprising enabling the advertiser to specify a specification of a number of ad impressions.

22. The method of claim 15, further comprising enabling the advertiser to upload an ad.

23. The method of claim 15, further comprising enabling the advertiser to specify a payment.

24. The method of claim 15, further comprising enabling the advertiser to upload a new ad in response to a change in at least one of advertising strategy, current events, target household, and viewer feedback.

25. The method of claim 15, wherein enabling a TV-viewing household access to the online targeted advertising exchange comprises enabling the TV-viewing household to bid on the identified ad avails.

26. The method of claim 15, wherein enabling an advertiser access to the online targeted advertising exchange comprises enabling the advertiser to bid on the identified ad avails.
